(19) United States
(12) Patent Application Publication
(10) Pub. No.: US 2004/0066124 A1
(43) Pub. Date: Apr. 8, 2004

(54) Spark plug with elastically and plastically improved gasket

(75) Inventors: Keiji Kanao, Aichi-ken (JP); Tsunetoshi Goto, Handa-shi (JP); Nobuo Abe, Yokkaichi-shi (JP); Hirofumi Suzuki, Kuwana-shi (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref (JP)

(21) Appl. No.: 10/674,460

(22) Filed: Oct. 1, 2003

(30) Foreign Application Priority Data
Oct. 8, 2002 (JP) 2002-295003

(51) Int. Cl. H01T 13/04

(52) U.S. Cl. 313/135

(57) ABSTRACT

An object of the present invention is to provide a spark plug gasket (provided on the outer surface of the metal member of a spark plug) which assures a sealing between the spark plug and engine head by elastically deforming itself during screwing in the spark plug into an engine head and at the same time does not easily suffer an plastic deformation during driving the engine. The two requirements for assuring the close contact capability and suppressing the plastic deformation are simultaneously satisfied by a twice or three-times bent gasket with Hv0.5 of greater than or equal to 200 and smaller than or equal to 400. particularly, the twice bent gasket of the thickness of the gasket plate itself of 0.3 mm and made of SUS 304 of Hv0.5 of 350 did hardly suffer a loss of springiness under 50 G vibration.

### BACKGROUND OF THE INVENTION

1. Field of the Invention

The present invention relates to a spark plug with an elastically and plastically improved gasket for sealing between a spark plug and engine for an automobile, co-generation or gas pressure-pump.

2. Description of the Related Art

A conventional spark plug for an engine of an automobile, co-generation, or gas pressure-pump includes in general: a cylindrical metal member provided around the outer surface of itself with a screw for fixing the spark plug to the engine; a center electrode fixed inside an insulator in the spark plug; and an earth electrode (welded to the cylindrical metal member) disposed opposite to the center electrode which forms a spark gap together with the earth electrode.

The above-mentioned conventional spark plug is fixed to the engine head by a female screw of the engine head and male screw of the cylindrical metal member of the spark plug. Further, a gasket is provided around the outer surface of the cylindrical metal member in order to seal between the engine and cylindrical metal member, as disclosed, e.g., in JP 2000-164318A and UM50-71635A (Japanese Laid-Open Utility Model Application Sho 50-71635, 1975).

The above-mentioned conventional spark plug was made of low carbon steel. Recently, the force applied to the gasket has become increased, as the combustion temperature has benn raised and engine vibration has been increased, due to the lean burn and high power.

Any plastic deformation of the gasket should not be generated during operating the engine.

The gasket has a small radius of curvature bent portion bent by an axial force exerted by the screwing-in of the metal member of the spark plug into the engine head. The axial force is maintained by an elastic force generated by the bent portion of the metal member, thereby sealing between the spark plug and engine.

However, as the force applied to the gasket is increased, the plastic deformation is gradually caused, thereby reducing the over-all height of the gasket measured at the cross section along the radial direction and reducing the elastic force. Thus, the loss of springiness causes the sealing between the spark plug and engine to become insufficient.

Ultimately, the loss of springiness may possibly cause the spark plug to come loose out of the engine. Accordingly, at a first glance, it may seem better to increase a hardness of the gasket.

However, the gasket has a limited elasticity. Accordingly, an excessively increased gasket strength in order to suppress the loss of springiness causes a difficulty of the elastic deformation of the gasket and therefore degrades its sealing capability.

### SUMMARY OF THE INVENTION

An object of the present invention is to provide a spark plug with an improved gasket which: assures a sealing between the spark plug and engine head by elastically deforming itself during screwing in the spark plug into an engine head; and at the same time does not easily suffer an plastic deformation during driving the engine. Therefore, elements other than the gasket can be modified, if necessary.

The present invention is based on experiments of the inventors on gaskets with a various number of bent portions and with various hardness.

The spark plug of the present invention is provided with a cylindrical metal member with a screw for screwing in said metal member into an engine.

Further, a center electrode is fixed inside said metal member through an insulator.

Further, an earth electrode is welded to said metal member for forming a spark gap together with said center electrode.

The elastically and plastically improved gasket is provided around the outer surface of said metal member in order to seal between said metal member and engine.

The gasket is characterized in that it is bent at a plurality of positions along its radial direction.

The two requirements for assuring the close contact capability and suppressing the plastic deformation during operating the engine are simultaneously satisfied by the gasket with Vickers hardness of greater than or equal to 200 and smaller than or equal to 400.

The bent portions may be two at the cross section along the radial direction. In this case, the gasket may be made of an Fe alloy with Cr content of greater than or equal to 15 wt. % and smaller than or equal to 40 wt. %.

Further, the bent portions may be three at the cross section along the radial direction. In this case, the gasket may be made of an Fe alloy with Cr content of greater than or equal to 15 wt. % and smaller than or equal to 20 wt. %.

The Vickers hardness (Hv) depends upon the Cr content in the Fe alloy. Although Hv of the three-times bent type may be about the same as that of the twice bent type, it may more preferably be smaller than that of the twice bent type, because the three-times bent type becomes structurally harder due to an increased number of the bent portions. Further, this is because the tree-times bent type is not easily bent due to the increased number of the bent portions, compared with the twice bent type.

Further, the plate thickness of said gasket may preferably be greater than or equal to 0.2 mm and smaller than or equal to 0.4 mm. This is because, if the plate thickness is smaller than 0.2 mm, the gasket becomes too easily deformed, while, if the plate thickness is greater than 0.4 mm, the gasket becomes too hardly deformed.

Further, the gasket inaccordance with the present invention was confirmed to be suitable for a future engine which may generate a vibration greater than 10 G, although the conventional engine generates a vibration smaller than 10 G. The experimental result showed that the loss of springiness of the gasket in accordance with the present invention was hardly lost up to 50 G.

### BRIEF EXPLANATION OF THE DRAWINGS

FIG. 1 is a partial cross sectional view of a spark plug S1 including an elastically and plastically improved gasket in accordance with the present invention.

FIGS. 2A and 2B are enlarged partial cross sectional views (along the radial direction) of the two types of the gasket rings which are twice bent and three-times bent, respectively.

FIGS. 3A and 3B are enlarged partial cross sectional views (along the radial direction) of the other two types of the gasket rings of which are once bent and four-times bent, respectively.

FIG. 4 shows an experimental relation between the gasket height “h” after being elastically deformed under a prescribed screwing-in load and Vickers hardness of the gasket.

FIG. 5 shows an illustration for defining the loss of springiness Δh by the over-all height “h” after the elastic deformation under the prescribed load subtracted by “h′” after the plastic deformation under an additional load.

FIG. 6 shows an experimental relation between Δh and Vickers hardness for the twice and thre-times bent types of the gaskets, when the gasket is plastically deformed under a load over 10 G.

FIG. 7 shows an experimental relation between Δh and vibration for the conventional gasket and the gasket in accordance with the present invention.

FIGS. 8A to 8E are partial cross sectional views along the radial direction of modified shapes of the gaskets.

### PREFERRED EMBODIMENT OF THE INVENTION

The preferred embodiment of the present invention is explained, referring to the drawings.

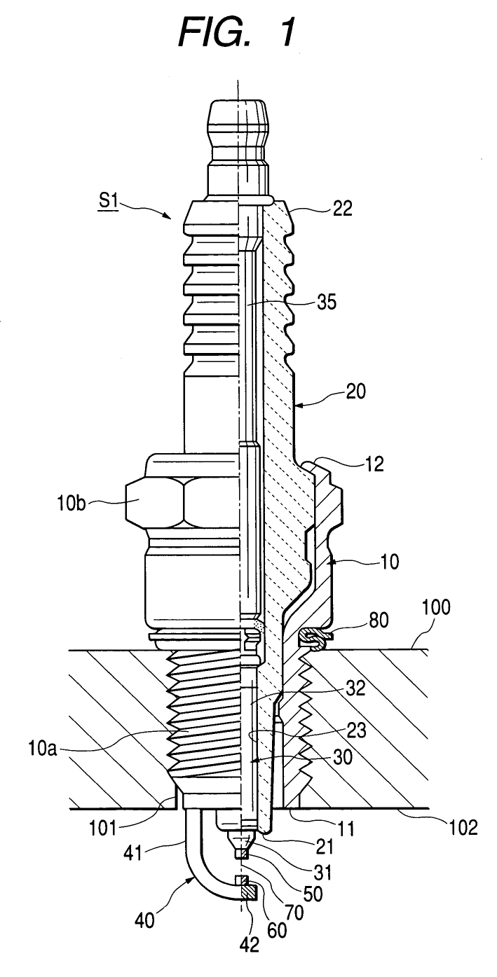

FIG. 1 is a partial cross sectional view of a spark plug S1 including an elastically and plastically improved gasket in accordance with the present invention.

The spark plug S1 is mounted on the automobile engine in such a manner that it is screwed in into a screw 101 provided in an engine head 100 forming an engine combustion chamber 102.

The spark plug S1 has a hausing (cylindrical metal member) 10. There are provided around the outer surface of the metal member 10a screw 10a for screwing in itself into the engine head 100 and a nut 10b for rotating the metal member 10 during screwing in the screw 10a.

Further, there is fixed inside the metal member 10 an insulator 20 made of, e.g., alumina ceramics Al₂O₃. One and the other ends 21 and 22 of the insulator 20 are exposed from one and the other ends 11 and 12 of the metal member 10, respectively.

Further, there is fixed in an axial hole 23 of the insulator 20 a center electrode 30. Therefore, the center electrode 30 is electrically insulated from the metal member 10. The center electrode 30 is a cylinder inside of which is made of a highly thermal conductive and metallic material, e.g., Cu and at the same time outside of which is made of a highly heat-resisting, corrosion-resisting and metallic material, e.g., Ni alloy.

Further, one end 31 of the center electrode 30 is extended to and exposed from one end 21 of the insulator 20, while the other end 32 of the center electrode 30 is electrically connected with a stem 35 which is exposed from the other end 22 of the insulator 20. Thus, the center electrode 30 can be electrically connected through the stem 35 with external wires.

On the other hand, an earth electrode 40 is made of Ni alloy, Fe alloy or Co alloy. One end 41 of the earth electrode 40 is welded to the one end 11 of the metal member 10 and is bent nearly at its middle point, thereby being extended toward the center electrode 30 in such a manner that the other end 42 of the earth electrode 40 is disposed opposite to the one end 31 of the center electrode 30.

Further, a tip 50 of a noble metal, e.g., Pt or Ir, may be welded at the one end 31 of the center electrode 30, while a tip 60 of a noble metal, e.g., Pt or Ir, may be welded at the other end 42 of the earth electrode 40. Thus, a spark gap 70 is formed between the tip 50 and tip 60.

A male screw 10a of the metal member 10 is screwed in into a female screw 101 of the engine head 100 by rotating the nut 10b, thereby fixing the spark gap 70 at a prescribed position of the combustion chamber.

Further, there is provided around the outer surface of the metal member a gasket ring 80 which maintains a screw force, thereby sealing between the metal member 10 and engine head 100 in such a manner that the gas in the combustion chamber 102 cannot be leaked.

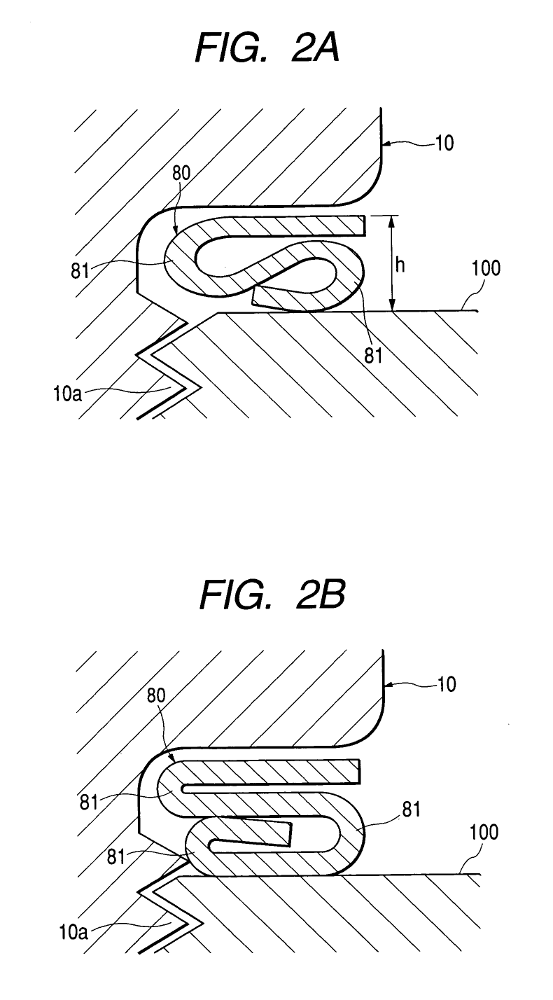

FIGS. 2A and 2B are enlarged partial cross sectional views (along the radial direction) of the two types of the gasket rings 80 which are twice bent and three-times bent, respectively. The radius of curvatures of the bent portions 81 are made small by the axial force generated by the screwing-in process.

In other words, the gasket ring 80 is pressed and deformed between the metal member 10 and engine head 100 by the axial force which is maintained by an elastic force generated by the bent portion 81.

FIG. 2A shows a twice bent S-shaped gasket ring 80, while FIG. 2B shows a three-times bent S-shaped gasket ring, wherein one end of the S-shape is further bent into the S-shape.

Those gasket rings 80 assure an close contact between the metal member 10 and engine head 100 and at the same time suppress a plastic deformation, even when a force greater than the conventional force is applied to themselves.

Next, concrete structures of those gasket rings 80 are explained.

First, the Vickers hardness of the twice bent gasket ring 80 is greater than (G.E) or equal to (E.T.) 200 and smaller than (S.T.) or E.T. 400. Here, the Vickers hardness is Hv0.5 defined by JIS:22244, wherein the hardness is measured under a testing load 4.903 N in the prescribed cmicro Vickers hardness testing method.

An Fe alloy such as SUS 304 or SUS 301 of which Cr content is G.E./E.T. 15 wt. % and S.T./E.T. 40 wt. % is employed, in accordance with the above-mentioned hardness requirement.

Although Hv0.5 of the three-times bent type may be about the same as that of the twice bent type, it may more preferably be smaller than that of the twice bent type, because the three-times bent type becomes harder structurally due to an increased number of the bent portions. Further, this is because the three-times bent type is not easily bent due to the increased number of the bent portions, compared with the twice bent type.

Therefore, an Fe alloy such as SUS 304 of which Cr content is G.E.or E.T. 15 wt. % and S.T. or E.T. 20 wt. % is employed for the three-times bent type, taking into consideration the fact that the hardness is increased, as the Cr content is increased.

Further, the plate thickness of the twice bent type and three-times bent type may preferably be G.T./E.T. 0.2 mm and S.T/E.T. 0.4 mm. This is because if the plate thickness is S.T 0.2 mm, the gasket becomes too easily deformed, while if the plate thickness is G.T. 0.4 mm, becomes too hardly deformed.

By using the spark plug S1 thus constructed, discharges is caused at the spark gap 70, thereby igniting an air/fuel mixture in the combustion chamber 102, growing up a flame nucleus and combusting the fuel.

Next, the reason why the above-mentioned two types of the gasket 80 was employed is explained.

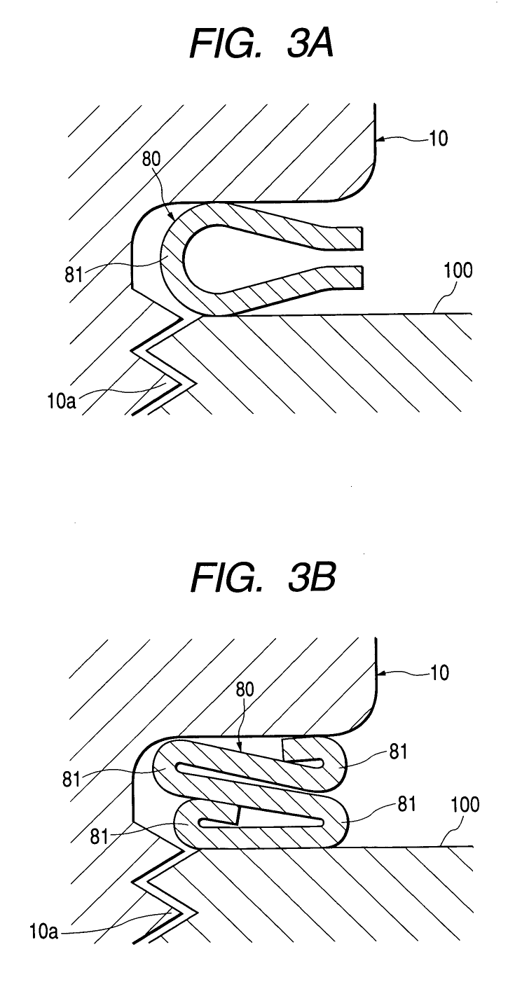

The reason was experimentally confirmed by comparing the above-mentioned two types with a once bent type as shown in FIG. 3A and a four-times bent type as shown in FIG. 3B.

The comparison experiments are made for the four types of the gaskets 80, wherein Hv0.5 is G.T./E.T. 100 and S.T./E.T. 400 and the plate thickness is 0.3 mm.

First, an initial close contact capability (close contact capability when the spark plug is fixed to the engine head for the first time) was inspected by the over-all height “h” after the elastic deformation due to the axial force during the screwing-in of the gasket 80 as shown in FIG. 2A. The over-all height “h” is measured along the axial force direction (along the axial direction of the spark plug S1).

In general, the over-all height of the gasket 80 before the elastic deformation (before fixing it to the engine head 100) is about 2.2 mm. The gasket is pressed and deformed by the tight screwing, thereby reducing the over-all height of the gasket 80.

Usually, the screwing torque is 20 to 30 N·m, thereby generating the axial force of about 6 kN. For reference, The Japanese Industrial standards (JIS) recommend that the over-all height “h” after the elastic deformation be preferably 1.6±0.4 mm under the screwing torque is 20 to 30N·m.

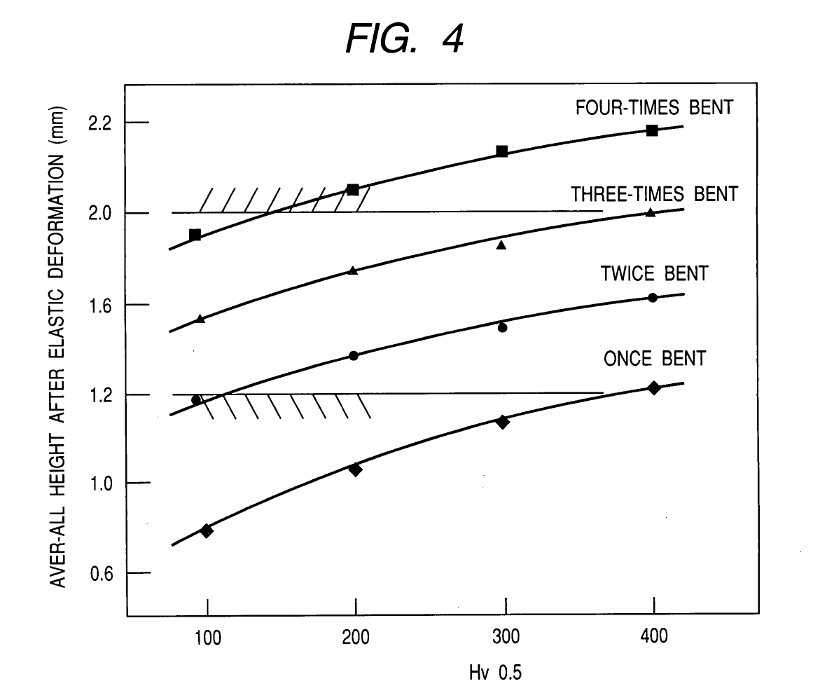

FIG. 4 shows an experimental relation between the over-all height “h” after the elastic deformation and Hv0.5 regarding the four kinds of bent numbers of the gaskets.

In accordance with the above-mentioned JIS recommendation, the gasket 80 can assure the close contact capability, if the over-all height “h” after the elastic deformation is within 1.2 to 2.0 mm.

As shown in FIG. 4, The over-all height “h” after the elastic deformation are apt to increase, as the number of the bent portions are increased and Hv0.5 is increased. Further, it is understood that “h” is within the target range of 1.2 to 2.0 mm recommended by JIS, when the umber of the bent portions are two or three and Hv0.5 is 150 to 400.

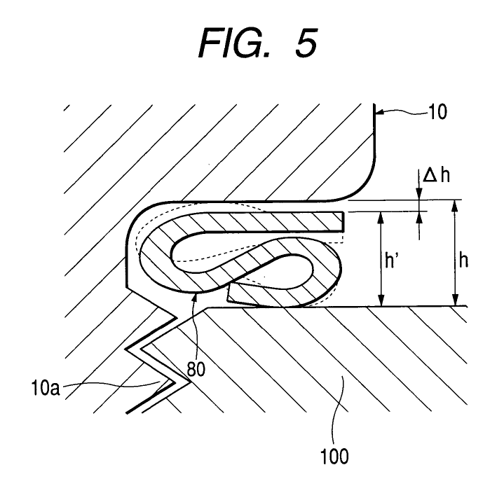

Next, the plastic deformation was experimentally inspected by a difference Δh between “h” after the elastic deformation due to the screwing and “h′” after the plastic deformation under additional load on the gasket 80, as shown in FIG. 5.

The aver-all height “h′” (after the plastic deformation) was measured, when “h” (after the elastic deformation) was made 1.6 mm, then the gasket 80 was pressed by an additive load of 9 kN and the additive load was finally released to zero. Accordingly, Δh is equal to (1.6−h′).

Here, the load of 9 kN is equivalent to the force applied to the gasket 80 by a thermal stress or vibration during operating the future high vibration engine of which vibration is supposed to be over 10 G.

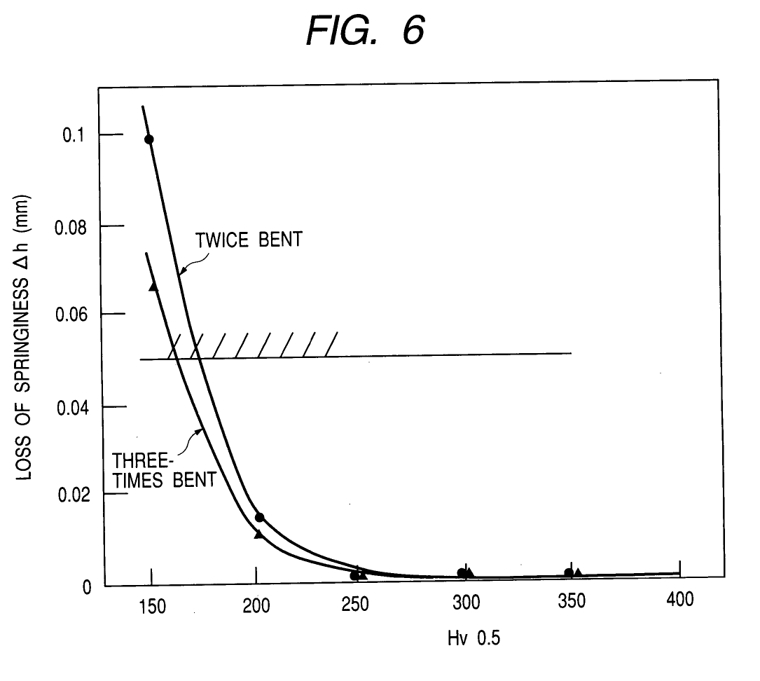

FIG. 6 shows an experimental relation between Δh and Hv0.5 for the twice bent and three-times bent types, under the above-mentioned load condition.

The target Δh was supposed to be S.T. 0.05 mm, because it is known that the axial force by the screwing is not hardly reduced.

As shown in FIG. 6, it is understood that the target loss of springiness Δh of S.T. 0.05 mm can be surely accomplished, when Hv0.5 is G.T/E.T. 200. Thus, the plastic deformation of the gasket 80 with Hv0.5 of G.T/E.T. 200 is suppressed, even when a force greater than the conventional force is applied to the gasket 80 during operating the engine.

The two requirements for assuring the close contact capability and for suppressing the plastic deformation are simultaneously satisfied by a twice or three-times bent gasket 80 as shown in FIG. 4 with Hv0.5 of G.T./E.T. 200 and S.T./E.T. 400 as shown in FIG. 6. However, higher Hv0.5 is not suitable for bending the three-times bent type. Therefore, an Fe alloy with Cr content of over 20 wt. %, e.g., SUS301, may possibly causes a crack at the bent portions or may not be easily bent, if it is used for the three-times bent type.

On the other hand, smaller Hv0.5 material such as an Fe alloy with Cr content of G.T./E.T. 15 wt. % and S.T./E/T. 20 wt. %, e.g., SUS 304 is acceptable for the three-times bent type.

As explained above, the gasket in accordance with the present invention can assure the close contact between the spark plug and engine head by the elastic deformation due to the initial tight screwing and at the same time it hardly suffers the plastic deformation, even when a force greater than the conventional force is applied to itself.

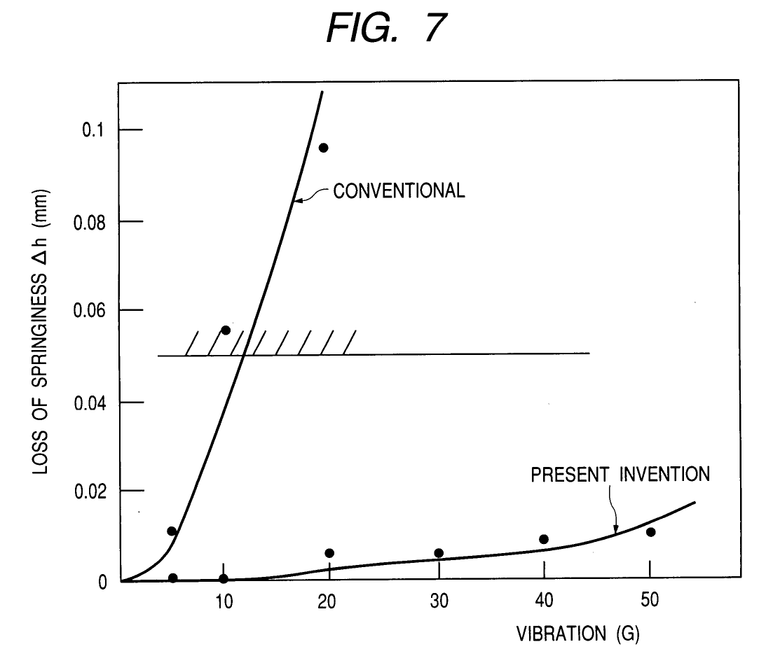

Actually, as shown in FIG. 7, it was confirmed that the gasket in accordance with the present invention is effective for an engine which generates a vibration greater than 10 G and exerts on the gasket a greater force than conventional engines.

FIG. 7 shows an experimental relation between the loss of springiness Δh in mm and vibration in G, concerning the twice bent type of the thickness of the gasket plate itself of 0.3 mm and made of SUS 304 of Hv0.5 of 350 for the gasket in accordance with the present invention. On the other hand, the conventional gasket was of the twice bent types the thickness of the gasket plate itself of 0.4 mm and made of a low carbon steel of Hv0.5 of about 150. Δh was measured after vibrating for 10 hours at 300 Hz at 180° C.

The experimental result shows that the loss of springiness Δh of the conventional was hardly observed below 10 G but it became drastically greater than the target Δh of 0.05 mm over 10G.

On the other hand, Δh of the gasket of the present invention remained under the target Δh of 0.05 mm up to 50 G which was a limiting capability of the testing apparatus.

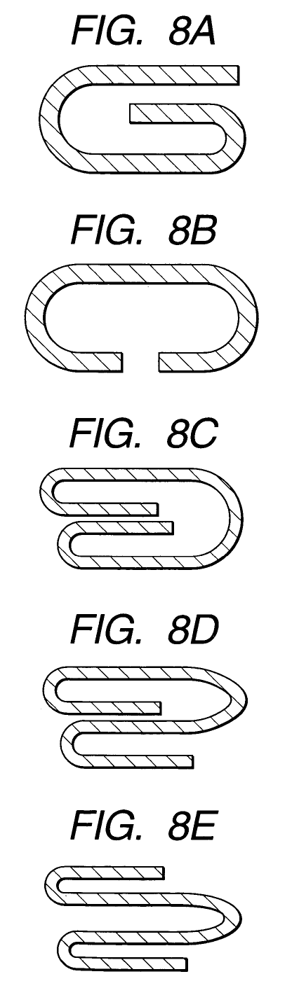

The cross sectional shapes of the gasket are not limited to FIGS. 2A, 2B, 3A and 3B. Other examples of the twice bent type are a U-shape of which one end is bent inside the U-shape as shown in FIG. 8A and a C-shape as shown in FIG. 8B, while other examples of three-times bent type are a U-shape both of which ends are bent inside the U-shape as shown in FIG. 8C, a U-shape wherein one end is bent inward and the other end is bent outward as shown in FIG. 8D and a U-shape both of which ends are bent outward as shown in FIG. 8E.

What is claimed is:

1. A spark plug, comprising:
a cylindrical metal member with a screw for screwing in said metal member into an engine;
a center electrode fixed inside said metal member through an insulator;
an earth electrode welded to said metal member for forming a spark gap together with said center electrode; and
a gasket provided around an outer surface of said metal member for sealing between said metal member and engine,
wherein said gasket:
is bent at two positions; and
is of Vickers hardness of greater than or equal to 200 and smaller than or equal to 400.

2. The spark plug according to claim 1, wherein said gasket is of an Fe alloy with Cr content of greater than or equal to 15 wt. % and smaller than or equal to 40 wt. %.

3. A spark plug, comprising:
a cylindrical metal member with a screw for screwing in said metal member into an engine;
a center electrode fixed inside said metal member through an insulator;
an earth electrode welded to said metal member for forming a spark gap together with said center electrode; and
a gasket provided around an outer surface of said metal member for sealing between said metal member and engine,
wherein said gasket:
is bent at three positions; and
is of an Fe alloy with Cr content of greater than or equal to 15 wt. % and smaller than or equal to 20 wt. %.

4. The spark plug according to claim 1, wherein a plate thickness of said gasket is greater than or equal to 0.2 mm and smaller than or equal to 0.4 mm.

5. The spark plug according to claim 3, wherein a plate thickness of said gasket is greater than or equal to 0.2 mm and smaller than or equal to 0.4 mm.

6. The spark plug according to claim 1, wherein said engine generates a vibration greater than 10 G.

7. The spark plug according to claim 3, wherein said engine generates a vibration greater than 10 G.
